(19) United States
(12) Patent Application Publication
(10) Pub. No.: US 2002/0197902 A1
(43) Pub. Date: Dec. 26, 2002

(54) Wire-harness connector of electric apparatus

(76) Inventor: Won-Cheal Kwak, Gwangmyoung-shi (KR)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/923,740

(22) Filed: Aug. 7, 2001

(30) Foreign Application Priority Data
Jun. 26, 2001 (KR) 2001-36571

(51) Int. Cl. H01R 13/627

(52) U.S. Cl. 439/352

(57) ABSTRACT

A wire-harness connector for an electric apparatus. The first locking device couples a terminal part of an electric apparatus and a connector body, the second locking device couples an inside of the connector body with the wire-harness, and the third locking device prevents the first locking device from being released so that a release device of the first locking device can not be unintentionally operated. The wire-harness connector includes an insertion control device positioned between first locking device and third locking device. The insertion control device includes an insertion control section formed on a release preventing mechanism for obstructing the release preventing mechanism.

### BACKGROUND OF THE INVENTION

1. Field of the Invention

The present invention relates to a wire-harness connector of an electric apparatus, and more particularly, to a wire-harness connector of an electric apparatus for connecting an electric apparatus in a place having severe vibration, such as a car engine, which can ensure a basic coupling between the electric apparatus and a connector body and ascertain the coupled condition with ease by arranging control means to be interlocked between locking means of the connector.

2. Background of the Related Art

In general, a control apparatus for controlling a power source and a wiring of an electric apparatus are connected to each other through a connector.

In particular, a wiring in a place having severe vibration, such as an engine room on which an ignition apparatus is installed, requires a wire-harness and a battery apparatus to be connected to each other.

In detail explanation, the ignition apparatus boosts a voltage in a power supplying part 1 through an ignition coil part 2 and supplies the boosted voltage to a spike plug 3, as shown in FIG.1.

In the ignition apparatus, an ignition timing is currently controlled by a control unit 4, whereby the ignition apparatus is controlled in an electronic manner to maintain an optimum ignition condition through advance and lag of the ignition timing.

For this, the power supply part 1, the ignition coil part 2 and the spike plug 3 are interconnected by means of the control unit 4. The connector is installed on the wire-harness, which is a power supplying line, and the ignition coil part 2, which is the electric apparatus.

Meantime, if the power supplying line of the ignition apparatus has a defect in its connection, there may happen an engine misfire, leading to an accident where an unburnt fuel is exploded in an exhaust system. Therefore, the connector requires connection ensuring means.

The conventional connector is provided with first, second, and third, or multi-stage locking means for the purpose of ensuring a coupling between a terminal 5 of the electric apparatus (ignition coil part) 2 and a crimp style terminal 7 arranged on a front end of the wire-harness 6.

In more detail, the terminal 5 of the electric apparatus forms a mail part and the crimp style terminal 7 forms a female part. The connector ensures the mail-female terminal coupling.

The connector is also divided into a mail part and a female part. A coupling body forming the mail part is formed on the electric apparatus, and a connector body 9 acts as an external cover forming the female part.

The first locking means for ensuring the coupling between the terminals of the connector couples the connector body as the external cover and an inner cover to maintain the coupling between the terminal and the crimp style terminal, in a manner that a hook protrusion 10 is formed on an outer peripheral surface of the coupling body 8, and a hook hole 11 being engaged with the hook protrusion 10 is formed on the connector body 9.

The hook protrusion 10 and the hook hole 11 have a front end, which is a slant surface. The slant surfaces are facing each other to induce the coupling between them. The hook hole 11 is integrally formed on a release lever 12 for releasing the hook coupling.

Further, the second locking means allows the crimp style terminal 7 to be fixed to the connector body 9. 6A fixing mechanism 13 interlocked with a separate fixing mechanism (not shown) is inserted. A cap 14 is mounted on a rear part of the crimp style terminal 7 to prevent foreign material penetration into the connector body 9 and fix the wire-harness 6.

Unexplained reference numerals 15 and 15′ are protectors for preventing an electric leakage.

Meanwhile, to release coupling between the coupling body 8 and the connector body 9 is made by releasing the hook coupling between them. Therefore, the hook hole 11 is integrally formed on the release lever 12 for a user to release the engagement between the hook protrusion 10 and the hook hole 11.

That is to say, referring to FIG.3, the hook hole 11 and the release lever 12 are formed on both ends about a retaining wall, such that if the release lever 12 is pressed, the hook hole 11 is raised up due to deformation of an elastic material, thereby releasing the engagement between the hook hole 11 and the hook protrusion 10.

Here, the release lever 12 is the release means of the hook coupling of the first locking means as stated above. Accordingly, in the event that there occurs a wrong operation, for example, a unskilled person, not a maintenance man, releases and shakes the release lever 12 of the connector, or the coupling is under a possibility of being released due to an external force including vibration, a release preventing mechanism 16 which is coupling ensuring means of the connector as third locking means is arranged in order to prevent unintentional release of the coupling.

That is to say, the release preventing mechanism 16 is inserted between the release lever 12 and the connector body 9 to support the release lever 12, so that in the case of unintentional operation of the release lever 12, the hook coupling of the first locking means can be prevented from being released when the release lever 12 is pressed.

The release preventing mechanism 16 includes a body 19 for being interacted with the retaining wall 18 which surrounds an outside of the release lever 12 of the connector body 9, and a guide jaw 21 being formed on the body 19 for being inserted into the connector body 9 along a guide groove 20 of a border part between the connector body 9 and the retaining wall 18.

A retaining jaw 22 is formed on one side of the body 19 to support the release lever 12 in a direction in which the retaining jaw is inserted into the connector body 9. Latch jaws 23 and 24 are formed on the retaining jaw 22 and a front side of the retaining jaw 22 to prevent a separation of the release preventing mechanism. A latch jaw 25, which is engaged with the latch jaws 23 and 24, is formed on an inside of the retaining wall 18.

Hence, if the release preventing mechanism 16 is positioned in a space between the release lever 12 and the connector body 9 and then is pressed in the direction of insertion, the retaining jaw 22 is inserted according to the guide of the guide jaw 21 and positioned on a lower part of the release lever 12.

At this time, whether the insertion is completed is ascertained by the interaction between the body 19 and the retaining wall 18. Once the insertion of the retaining wall 22 is completed, the latch jaw 23 on a rear side is engaged with the latch jaw 25 of the retaining wall 18, thereby preventing the release preventing mechanism 16 from being separated in the condition that the insertion is completed.

In the meanwhile, the insertion of the release preventing mechanism 16 is released in a manner that if the body 19 is backwardly drawn, the interaction of the retaining jaw 22 and the release lever 12 is released. At that time, since the latch jaw 24 on a front side is separated by some extent from the latch jaw 23 on the rear side, the release preventing mechanism 16 is prevented from being completely separated from the connector body 19 and missed when the insertion is released.

As previously mentioned, the electric apparatus, which is installed in a place having severe vibration, is provided with the connector for connecting the electric apparatus with the wire-harness and the locking means for ensuring the coupled condition.

However, the conventional electric apparatus has a disadvantage that the coupling of the connector cannot be reliably ensured by using just the locking means.

That is, although the first, second and third locking means, namely the multi-stage locking means are arranged on the connector as above, the locking means are operated in an independent manner and are not under a so-called interlock relation wherein the locking means ascertain other locking means' coupled condition.

It is possible that the first and third locking means are interlocked since the third locking means prevents the release of the coupling of the first locking means. However, the interlocked relation exists only when the coupling is released.

In detail, since the coupling between the hook protrusion 10 and the hook hole 11, and the interaction between the retaining jaw 22 and the release lever 12 are independently carried out from each other, the insertion of the retaining jaw 22 is not affected by whether the hook coupling of the first locking means is completed or not.

Accordingly, even if the coupling of the first locking means is not completed, it does not affect on the insertion of the release preventing mechanism, or the third locking means, but just obstructs the release lever 12 included in the first locking means from being pressed. The coupled condition of the first locking means is ascertained just depending on the user's skill.

That is to say, in consideration of an assembly line of the ignition coil part 2, which is mounted on the engine room as aforesaid, the coupling of the connector depends only on the user's skill, and the maintenance is also dependent on the skill of the management man. Therefore, if an unskilled person couples the connector or manages the coupling, the result may be serious.

By way of example, the coupled condition of the connector is ascertained in a manner that the hook is clicked, the deformation of the hook material and impact due to recovery are sensed with the user's hands. This ascertainment is generally carried out in work places, and still more in the narrow engine room in which a plurality of components are arranged.

However, the coupled condition of the connector is difficult to be ascertained by hearing the click sound, since the assembly lines of factories or service stations are so nosy for the user to hear the click because of the noise in the work places.

Further, the coupled condition of the connector is difficult to be ascertained by sensing it with the user's gloved hands during work.

In view that the coupled condition of the connector is just dependent on the user's skill, it increases a possibility that a wrong coupling is occurred in the connector.

When there happens the wrong coupling of the connector in the electric apparatus, if the ignition apparatus is used, a critical error may be generated in the engine operation. Actually, there was a case that an unburnt fuel was exploded due to heat of an exhaust system, and thus a catalytic converter which is an exhaust gas purifier was exploded, resulting in damages on expensive components.

### SUMMARY OF THE INVENTION

Accordingly, the present invention is directed to a wire-harness connector of an electric apparatus that substantially obviates one or more problems due to limitations and disadvantages of the related art.

An object of the present invention is to provide a wire-harness connector of an electric apparatus, which can easily ascertain a coupled condition of first locking means and ensure a coupling completed condition of the connector by inserting third locking means only when the coupling of the first locking means is completed.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a wire-harness connector of an electric apparatus includes insertion control means being positioned between first locking means and third locking means for permitting the third locking means, in other words, a pressure preventing mechanism to be inserted only when a coupling of the first locking means is completed, wherein the insertion control means includes an insertion control section being formed on the release preventing mechanism for obstructing a release preventing mechanism from being completely inserted by being interacted with an inside of a front end of a hook hole; an interaction jaw being formed on a retaining jaw of the release preventing mechanism for helping the insertion control section to obstruct the insertion by being backwardly protruded when the inserting control section and the hook hole are interacted and being interacted with a release lever; and an interaction release protrusion for releasing the interaction between the insertion control section and the hook hole by forcing the insertion control section to be bent when the hook protrusion is coupled with the hook hole.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a conceptual exemplary view of an electric apparatus to which a connector is applied;

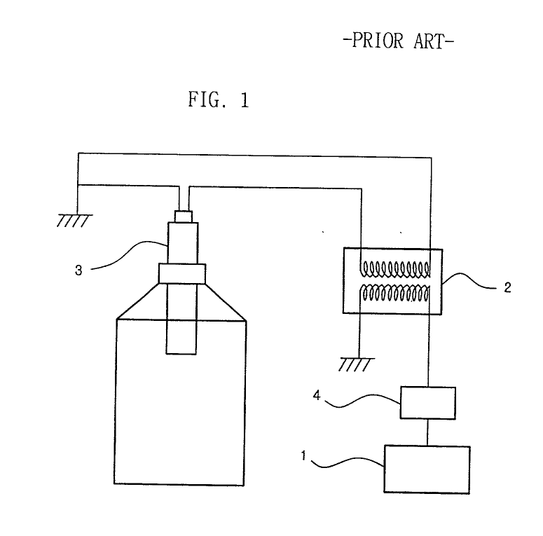

FIG. 2a illustrates an exploded cross view of a conventional connector;

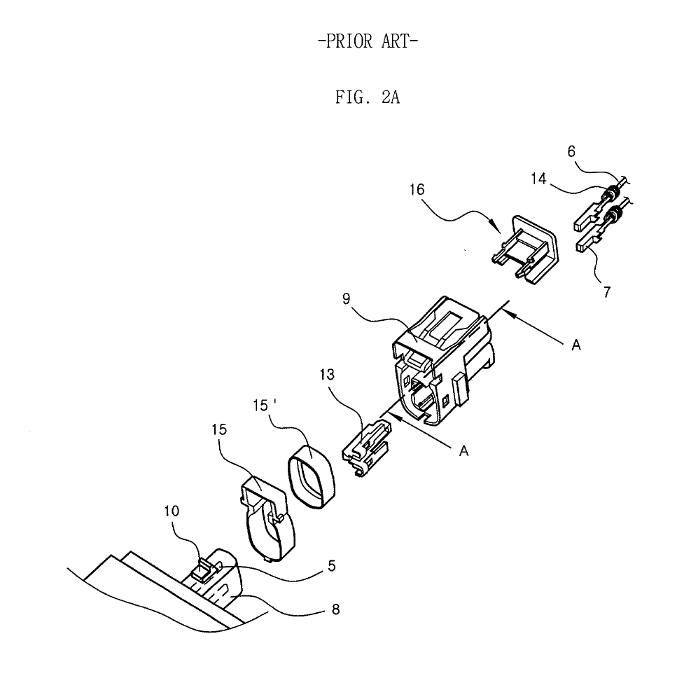

FIG. 2b illustrates a sectional view for explaining a state where the conventional connector is coupled, taken through A-A line of FIG. 2a ;

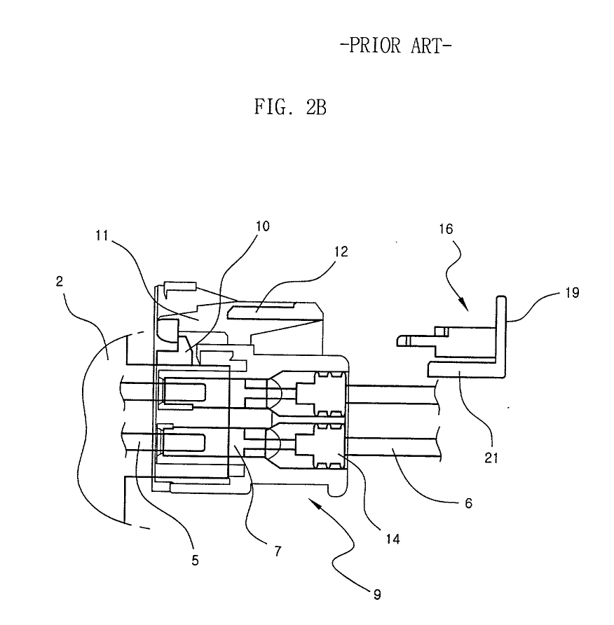

FIG. 3 illustrates an enlarged cut cross view of the conventional connector;

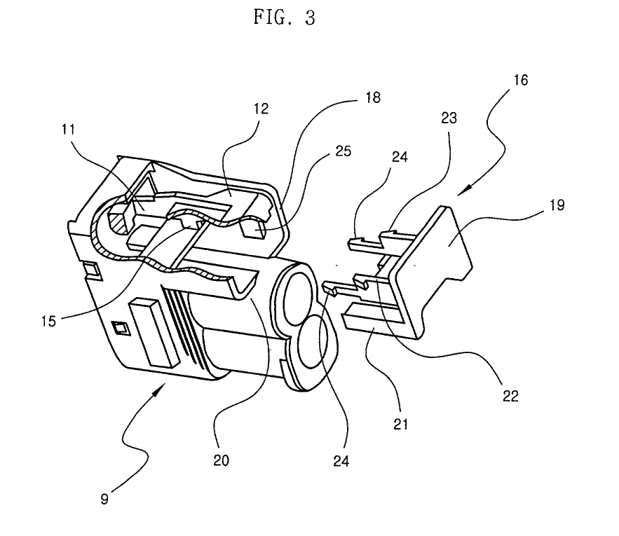

FIG. 4a illustrates an exploded cross view of a connector according to the present invention, corresponding to FIG. 2a;

FIG. 4b illustrates an enlarged cut cross view of the connector according to the present invention, corresponding to FIG. 3; and

FIG. 5a through FIG. 5C are sectional views for explaining a state that the connector is coupled according to the present invention, corresponding to FIG. 2b.

### DETAILED DESCRIPTION OF THE INVENTION

Reference will now be made in detail to the preferred embodiments of the present invention, examples of which are illustrated in the accompanying drawings.

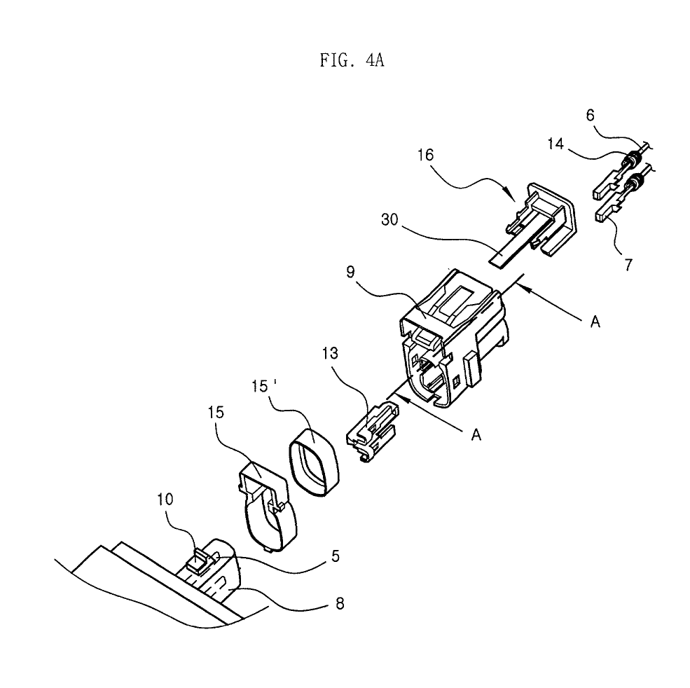

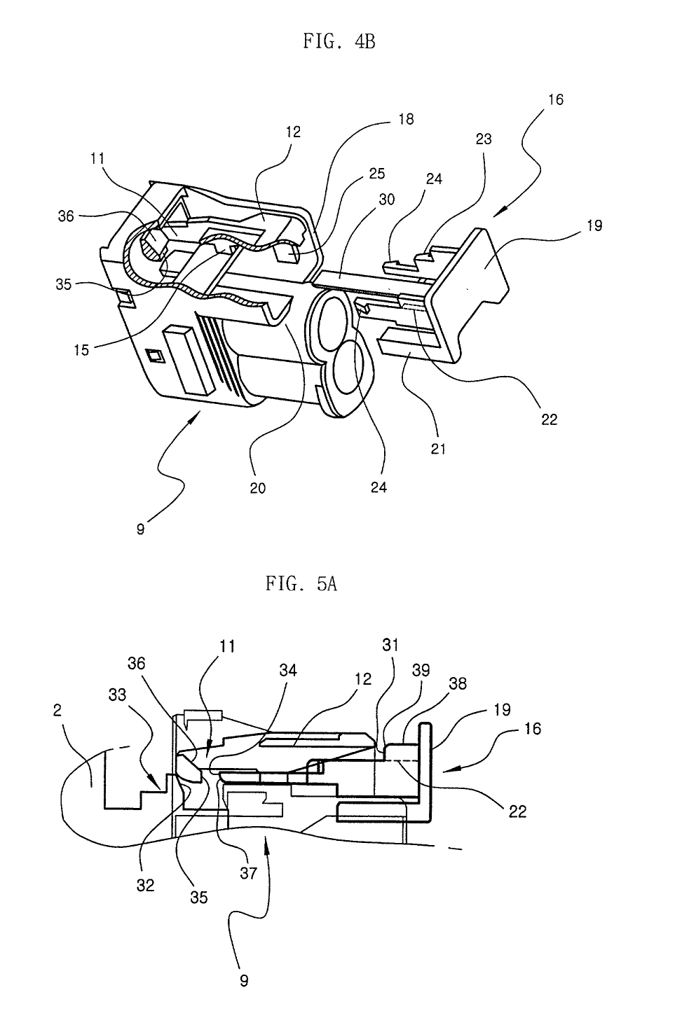

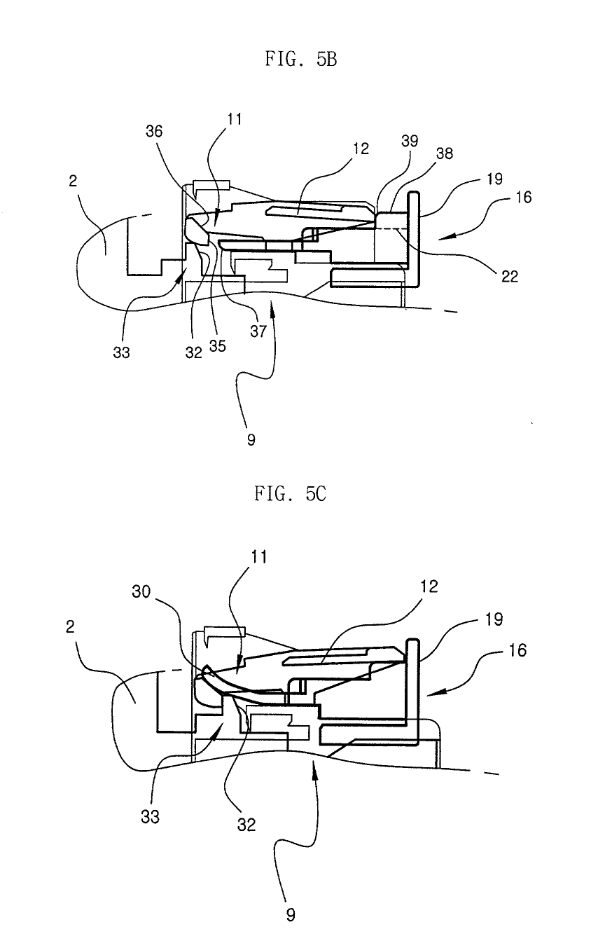

FIG. 4 illustrates an exploded cross view of a connector according to the present invention, and FIG. 5 illustrates a sectional view for explaining a state where the connector is coupled according to the present invention.

According to the present invention, only when a hook coupling of first locking means is completed such that a coupling body 8 on which a terminal 5 of an electric apparatus is formed is coupled with a connector body 9 which is coupled with a wire-harness 6 connected to the terminal 5, insertion control means permits third locking means, namely a release preventing mechanism 16 to be inserted. The present invention is related to a connector of the electric apparatus, whose coupling is carried out through the first locking means and the third locking means.

In the insertion control means, an insertion control section 30 is integrally formed on a body 19 of the release preventing mechanism and has a length sufficient to obstruct the release preventing mechanism 16 from being completely inserted, so as to be interacted with an end part within a front side of a hook hole 11.

An interaction jaw 31 including a guide surface 39 is formed on the release preventing mechanism 16 to help the insertion control section 30 to obstruct the insertion by being protruded on the retaining jaw 22 to be interacted with a rear end part of a release lever 12 when the insertion control section 30 is interacted with the end part within the hook hole 11.

In addition, a hook protrusion of the first locking means which is hook-coupled with the hook hole 11 becomes an interaction release protrusion 33, which includes an interaction release guiding surface 32 for releasing the interaction between the insertion control section 30 and the hook hole 11 by forcing the insertion control section 30 to be bent.

Here, it is sufficient if the insertion control section 30, which obstructs the complete insertion, is as long as a length adaptable to maintain the separation in the conventional art, which were previously described. The separation was determined by arrangement of latch jaws 23 and 24, which are formed on a side part of the release preventing mechanism 16.

Therefore, it is sufficient if the insertion control section is as long as the separation from the body 19 of the release preventing mechanism plus extension from the end of the separation up to the end part within the front side of the hook hole 11.

In accordance with the length of the insertion control section 30, the interaction jaw 31 is formed to help the insertion control section 30 to obstruct the release preventing mechanism 16 from being inserted. The interaction jaw 31 helps the interaction of the insertion control section 30 by being interacted with a front end of the release lever 12.

The interaction jaw 31 more obstructs the insertion of the release preventing mechanism 16 under a state that the hook coupling of the first locking means is not completed and there exists a serration between the hooks.

That is to say, if the hook protrusion, which is the interaction release protrusion 33 included in the insertion control means, is contacted with a slant surface of the hook hole 11 and the hooks are deformed, an end part of the release lever 12 is lowered toward a retaining jaw 22.

For the reason, the lower end part of the release lever 12 is positioned lower than the guide surface 39 of the interaction jaw 31, and a large portion of a surface of the end part of the release lever 12 is interacted with the interaction jaw 31 and the retaining jaw 22, making the insertion of the release preventing mechanism 16 more difficult.

The interaction jaw serves to prevent the insertion control section from being forcibly deformed by virtue of an elastic force resistant to the deformation of the hooks, when the user presses the release preventing mechanism to couple the connector.

That is, if the user presses the body 19 of the release preventing mechanism 16 under a condition that the hook coupling of the first locking means is not completed, the hooks are interacted with each other, causing the largest resistance pressing the body 19.

At that time, the release lever is positioned at a lower part of the interaction jaw, and thus reliably enacted with the interaction jaw. In consequence, the interaction jaw serves to help the long type insertion control section 30 to prevent the insertion control section 30 from being forcibly bent.

In the meantime, according to the present invention, since the hook hole 11 of the first locking means and the hook protrusion, namely the interaction release protrusion 33 are included in the insertion control means together with the insertion control section 30, the hook hole for controlling the insertion has a limit in taking its shape.

To be specific, the end part within the front side of the hook hole 11 should be formed in a direction perpendicular to a direction of insertion of the insertion control section 30 in order to obstruct the release preventing mechanism 16 from being inserted by being interacted with the insertion control section 30.

The insertion control section 30 is induced bent by the interaction release protrusion 33. Thus, it is natural that the insertion control section 30 is formed of an elastic material. If a surface, which is interacted with the insertion control section 30, is set to be slant, the obstruction of the insertion of the release preventing mechanism 16 is not achievable due to the induction of the bending when the insertion control section 30 is inserted.

Consequently, the interaction surface 35 forms a surface perpendicular to the direction of the insertion of the insertion control section 30 at a position where the insertion control section 30 is inserted and interacted when the interaction release protrusion 33 is not coupled in the end part within the front side of the hook hole 11, whereby the interaction surface 35 is interacted with an interaction surface 34 of the insertion control section 30.

Furthermore, when the interaction between the insertion control section 30 and the hook hole 11 is released by the interaction release protrusion 33, and a guide surface 36 is extended on the interaction surface 35 with the interaction release guiding surface 32 of the interaction release protrusion 33.

In the insertion control section 30, the interaction surface 34 corresponding to the interaction surface 35 of the hook hole 11 is also formed in a direction perpendicular to the direction of insertion of the insertion control section 30. A guide surface 37 faces the interaction release guiding surface 32, so as to induce the insertion control section 30 to be bent by being extended from the interaction surface 34 and contacting with the interaction release guiding surface 32.

Thereupon, the direction of insertion of the insertion control section 30 was determined by an existing retaining wall 18 and a guide jaw 21 into a straight line.

On the other hand, a compressing protrusion 38 is formed on the interaction jaw 31 to maintain the insertion completed condition of the release preventing mechanism 16 by virtue of the elastic attachment of the release lever 12 when the release preventing mechanism 16 is completely inserted, and apply an elastic force to the hook coupling.

To be specific, the interaction jaw 31 acts as auxiliary means for helping the insertion obstruction of the release preventing mechanism 16 and as separation preventing means for certainly maintaining the inserted condition of the release preventing mechanism 16 through the compressing protrusion 38 as well as elastic retaining means for more ensuring the hook coupling of the first locking means.

In further detail explanation, if the inserted condition of the release preventing mechanism 15 is satisfied, in other words, the coupling of the first locking means is completed and the release preventing mechanism 16 is completely inserted into the connector body 9, the compressing protrusion 38 raises the release lever 12.

This means that the release lever 12 elastically attaches the compressing protrusion 38. Accordingly, since the inserted condition of the release preventing mechanism 16 is reliably maintained, the elastic attachment of the release lever 12 prevents the separation of the release preventing mechanism 16 although the connector body 9 trembles by vibration of an engine or the likes.

Besides, if the compressing protrusion 38 raises the release lever 12, the hook hole 11 and the hook protrusion are lowered in the coupled condition by the elasticity, so that the locked condition of the first locking means becomes more solid.

Thus, the interaction jaw 31, which is a border extended from the retaining jaw 22, helps the insertion obstruction of the release preventing mechanism 16 by being interacted with the release lever 12 when the first locking means is not coupled. The compressing protrusion extended on the interaction jaw 31 prevents the separation of the release preventing mechanism 16 and further firmly supports the hook coupling in the elastic manner by compressing the release lever 12 if the coupling of the first locking means is completed and the release preventing mechanism is inserted into a lower part of the release lever 12.

According to the present invention constructed as above, the hook coupling of the first locking means is a precondition for the insertion of the connector body 9 of the release preventing mechanism 16 which is the third locking means.

That is to say, when the connector on which the wire harness 6 is coupled through the second locking means is a unit product as an independent product, or when the coupling body 8 of the electric apparatus on which the terminal 5 is installed and the connector body are not completely coupled to be assembled, the third locking means is not coupled.

Operation of the present invention will be explained in detail herein after. If the connector is a unit product or the coupling is not completed, although the third locking means, in other words, the release preventing mechanism 16 is inserted into the connector body 9, the third locking means is not completely inserted since it is back spaced by a predetermined separation.

This is because the interaction surface 34 of the insertion control section 30 and the interaction surface 35 of the hook hole 11 are interacted with each other, and accordingly the insertion of the release preventing mechanism 16 is obstructed by the insertion control section 30. The interaction jaw 31 of the release preventing mechanism 16 is also interacted with the front end of the release lever 12, serving to help the insertion obstruction of the release preventing mechanism 16.

Even when the release preventing mechanism 16 is not completely inserted, the release preventing mechanism 16 is prevented from being separated with the aid of the aforesaid latch jaw 23.

In this case, if the coupling of the connector is not completed by the insertion control section 30 and the interaction jaw 31, the release preventing mechanism 16 is under the condition that it is not completely inserted into the connector body, maintaining the predetermined separation.

Next, if the coupling of the connector, in other words, the coupling of the coupling body 8 of the electric apparatus and the connector body 9 is completed and the hook coupling is completed, the interaction release protrusion 33 is inserted into the hook hole 11, such that the interaction release guiding surface 32 raises the insertion control section 30, resulting in the release of the interaction.

On the other side, since the guide surface 37 which faces the interaction release guiding surface 32 is formed on the insertion control section 30, the release is easily performed at a point of inserting the interaction release protrusion 33. Thereafter, if the release preventing mechanism 16 is pressingly inserted, the insertion control section 30 is moved along the interaction release guiding surface 32 and the guide surface 36 of the hook hole 11.

For the reason, under the unit condition, namely the independent condition of the connector, the release preventing mechanism 16 is not completely coupled and maintains the separated condition.

The separated condition can be ascertained with naked eyes. The coupled condition is also ascertained regardless of the skill.

Additionally, since the third locking means, or the release preventing mechanism 16 is not completely inserted if the locking of the first locking means is not completed in the assembly line of the connector and the electric apparatus, the user can ascertain whether the connector is coupled, and the ascertainment is not related to the user's skill.

As a result, since the coupled condition of the first locking means can be ascertained by ascertaining the insertion of the release preventing mechanism 16, the ascertainment of the connector is easily achieved and the coupling is further ensured by virtue of the elastic attachment of the release lever 12 through the compressing protrusion 38 and the elastic support of the first locking means.

As described above, the present invention has an advantage of preventing a wrong coupling of the first locking means for coupling the terminal of the electric apparatus with the wire-harness, which is the power supply line, since the insertion control means permits the ascertainment of the coupled condition of the first locking means to be conducted with ease and ensure the coupled condition by performing the insertion completion of the third locking means only when the coupling of the first locking means is completed

The present invention has another advantage of preventing the release preventing mechanism from being separated with the aid of the compressing protrusion, which is included in the insertion control means, as well as more firmly ensuring the hook coupling of the latch jaw.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A wire-harness connector of an electric apparatus, whose coupling is carried out through first and third locking means, the connector comprising insertion control means, which permits the third locking means, namely, a release preventing mechanism, to be inserted, only when a hook coupling of the first locking means is completed such that a coupling body on which a terminal of the electric apparatus is installed is coupled with a connector body on which a wire-harness connected to the terminal is coupled.

2. The connector of claim 1, wherein the insertion control means includes an insertion control section being integrally formed on a body of the release preventing mechanism and having a length sufficient to obstruct the release preventing mechanism from being completely inserted, the length reaching a position where the insertion control section is interacted with an end part within a front side of a hook hole; an interaction jaw being formed on the release preventing mechanism to help the insertion control section to obstruct the insertion by being protruded to be interacted with a rear end part of a release lever; and a hook protrusion of the first locking means which is hook-coupled with the hook hole, being an interaction release protrusion, which includes an interaction release guiding surface for releasing the interaction between the insertion control section and the hook hole by forcing the insertion control section to be bent.

3. The connector of claim 2, wherein an interaction surface is formed on the end part within the front side of the hook hole to form a surface perpendicular to a direction of the insertion of the insertion control section at a position where the insertion control section is inserted and interacted when the interaction release protrusion is not coupled, and to be interacted with an interaction surface of the insertion control section, and a guide surface is extended on the interaction surface along with the interaction release guiding surface of the interaction release protrusion when the interaction between the insertion control section and the hook hole is released by the interaction release protrusion.

4. The connector of claim 2, wherein the interaction surface corresponding to the interaction surface of the hook hole is also formed on the insertion control section in a direction perpendicular to the direction of insertion of the insertion control section, and a guide surface faces the interaction release guiding surface to induce the insertion control section to be bent by being extended from the interaction surface of the insertion control section and contacting with the interaction release guiding surface.

5. The connector of claim 2, wherein a guide surface is formed on the interaction jaw to guide the release lever to be moved, and a compressing protrusion is formed on the interaction jaw to maintain the insertion completed condition of the release preventing mechanism by virtue of an elastic attachment of the release lever when the release preventing mechanism is completely inserted, and additionally apply an elastic force to the hook coupling.
